(19) United States
(12) Patent Application Publication
(10) Pub. No.: US 2018/0254899 A1
(43) Pub. Date: Sep. 6, 2018

(54) METHOD AND SYSTEM FOR SECURE OPTICAL DATA TRANSMISSION

(71) Applicant: FRAUNHOFER-GESELLSCHAFT ZUR FÖRDERUNG DER ANGEWANDTEN FORSCHUNG E.V., München (DE)

(72) Inventors: Robert ELSCHNER, Berlin (DE); Johannes Karl FISCHER, Berlin (DE)

(73) Assignee: FRAUNHOFER-GESELLSCHAFT ZUR FÖRDERUNG DER ANGEWANDTEN FORSCHUNG E.V., München (DE)

(21) Appl. No.: 15/770,467

(22) PCT Filed: Nov. 16, 2015
(86) PCT No.: PCT/EP2015/076695

§ 371 Date: Apr. 23, 2018

(30) Foreign Application Priority Data
Oct. 23, 2015 (EP) 15191247.4

(51) Int. Cl. H04L 9/08; H04B 10/25; H04L 25/02

(52) U.S. Cl. CPC H04L 9/0875; H04B 10/2503; H04B 7/0413; H04L 9/0852; H04L 25/0202

(57) ABSTRACT

It is provided a method and a system for secure optical data transmission. The method includes the steps of providing a bi-directional optical communication link between a first and a second party; carrying out a first channel estimation with respect to the communication link by the first party; carrying out a second channel estimation with respect to the communication link by the second party; and generating a secret key using the results of the first and the second channel estimation.

### CROSS-REFERENCE TO A RELATED APPLICATION

This application is a National Phase Patent Application of International Patent Application Number PCT/EP2015/076695, filed on Nov. 16, 2015, which claims priority of European Patent Application 15191247.4, filed on Oct. 23, 2015.

### BACKGROUND

The invention relates to a method for secure optical data transmission and a system for secure optical data transmission.

Security is an important aspect of current communication systems. In particular, secret key generation for encryption systems is a field of intense research. Recent research in cryptographic theory has shown how information theoretic secrecy for e.g. secret key generation can be obtained from sources of so-called joint randomness under the assumption that a potential attacker does not share the same source of randomness (“joint randomness not shared by others—JRNSO”).

For example, with respect to optical fiber communications, JRNSO has been generated by using a large-scale Mach-Zehnder interferometer; as e.g. disclosed by K. Kravtsov, Z. Wang, W. Trappe, P. R. Prucnal, “Physical layer secret key generation for fiber-optical networks,” Optics Express, vol. 21, no. 20, p. 23756, September 2013. Measuring the phase difference induced in its two arms and relying on channel reciprocity, a joint randomness can be observed between two terminals. An attacker who taps the two interferometer arms would measure an uncorrelated phase difference. However, such a scheme requires two optical fibers and induces additional optical Tosses due to the input-output coupler of the interferometer.

Further, secure key distribution by means of quantum key distribution techniques have been disclosed (e.g. by the article B. Korzh, C. C. W. Lim, R. Houlmann, N. Gisin, M. J. Li, D. Nolan, B. Sanguinetti, R. Thew, H. Zbinden, “Provably secure and practical quantum key distribution over 307 km of optical fibre”, Nature Photonics, vol. 9, no. 3, p. 163, February 2015). However, such key distribution schemes often require components and system configurations which are expensive and not compatible with standard telecommunication equipment. Furthermore, the transmission reach and key capacity of such schemes is often limited.

### SUMMARY

It is an object of the invention to provide a method and a system for overcoming the above-mentioned deficiencies.

According to the invention, a method for secure optical data transmission is provided, the method comprising the steps of:
providing a bi-directional optical communication link between a first and a second party;
carrying out a first channel estimation with respect to the communication link by the first party;
carrying out a second channel estimation with respect to the communication link by the second party; and
generating a secret key or another token using the results of the first and the second channel estimation.

The first and second channel estimation in particular provide a source of joint randomness that is not shared by others. Accordingly, the method according to the invention may realize a method for the generation of joint randomness not shared by others (JRNSO).

The method according to the invention may be realized in a cost-efficient way since it does not require any additional hardware components compared to standard fiber-based optical communication systems and can be easily implemented in the digital signal processing units of the transponders used in such systems. In principle, the method allows for high secret key capacity with the ability to obtain new keys at almost arbitrary time scales; e.g. as often as the channel estimations can be carried out and depending on the time dependency of the variation of channel properties, which might vary on a micro-seconds timescale.

According to an embodiment of the invention, carrying out the first channel estimation comprises transmitting a pilot (training) sequence or (e.g. orthogonal) pilot sequences from the first to the second party and/or carrying out the second channel estimation comprises transmitting a pilot sequence (or a plurality of pilot sequences) from the second to the first party. Suited pilot sequences are disclosed e.g. in the article R. Elschner, F. Frey, C. Meuer, J. K. Fischer, S. Alreesh, C. Schmidt-Langhorst, L. Molle, T. Tanimura, C. Schubert, “Experimental demonstration of a format-flexible single-carrier coherent receiver using data-aided digital signal processing,” Optics Express, vol. 20, no. 27, p. 28786, December 2012, which in that respect is incorporated by reference herewith.

However, it is also possible that for carrying out the first and/or the second channel estimation no specific pilot sequences are used. Rather, the first and/or the second channel estimation may be carried out by using payload data transmitted over the bi-directional optical communication link. For example, blind adaptation algorithms might be used for processing the received payload data such that pilot sequences may not be required.

In particular, the first and the second channel estimation may be carried out at least approximately at the same point in time. For example, transmitting the pilot sequence from the first to the second party and transmitting the pilot sequence from the second to the first party is carried out at least approximately at the same point in time.

Further, the bi-directional optical communication link may be an M×N multiple input multiple output (MIMO) communication link. For example, the bi-directional fiber optical communication link is a 2×2 MIMO or a 4×4 MIMO link.

Using the results of the first and the second channel estimation at least one pair of correlated bit sequences is generated, the secret key being generated by means of the correlated bit sequences. Further, the first and/or the second channel estimation comprises determining coefficients of the impulse responses in the time domain and/or transfer functions in the frequency domain with respect to the communication link, wherein the coefficients related to the impulse responses and/or transfer functions may be quantized.

Eventually, the secret key is generated using the determined impulse responses and/or transfer functions. For example, at least one pair of correlated bit sequences is generated using the determined impulse responses and/or transfer functions and the secret key is generated using the correlated bit sequences.

Moreover, the bi-directional optical communication link may be established using a first transmitter unit and a first receiver unit on the side of the first party and using a second transmitter unit and a second receiver unit on the side of the second party.

The first and/or the second transmitter unit might be configured for transmitting signals via at least a first and a second optical transmission variant, wherein the first optical transmission variant e.g. is a first carrier polarization and the second optical transmission variant is e.g. a second carrier polarization. However, other optical transmission variants might be used such as the carrier frequency, a time division multiplexing time domain and/or a code division multiplexing code. Also, the first and/or the second transmitter unit may comprise a dual polarization UQ modulator.

Furthermore, the first and/or the second receiver unit may be configured for receiving signals transmitted via a first and a second carrier polarization.

The first and/or the second receiver unit may be configured for coherent detection, wherein the receiver units may be homodyne or intradyne receiver units. However, the invention is of course not restricted to homodyne and intradyne receivers. Rather, optical signals (both at the side of the first and the second party) might also be received by optical heterodyne receiver units. For example, using heterodyne receiver units, after a recovery of complex baseband signals, the first and the second channel estimation is carried out.

According to an embodiment of the invention, a 2×2 MIMO link (channel) might be realized by transmitting data (e.g. over a single mode optical fiber) in two orthogonal polarization states of a carrier signal and using e.g. a polarization and phase diversity coherent receiver. The input and output optical fields of the optical communication link are related by the frequency-dependent Jones matrix J(ω), which in the absence of polarization-dependent loss (PDL) is a unitary operator that describes the polarization evolution along the fiber due to coupling between the polarization modes (u₁, u₂, u₁* and −u₂* being frequency-dependent coefficients of the Jones matrix J(ω)):

$$J ( ω ) = [ \begin{matrix}{u}_{1} ( ω ) & {u}_{2} ( ω ) \\ - {u}_{2}^{*} ( ω ) & {u}_{1}^{*} ( ω )\end{matrix} ] \qquad ( 1 )$$

The coefficients u₁, u₂, u₁* and −u₂* of the Jones matrix J(ω) may be determined either directly by transmitting the above-mentioned training sequences, which may be evaluated at the receiver or indirectly by using adaptive filters with suitable update algorithms, wherein the filters (e.g. the corresponding filter coefficients) converge to the inverse Jones matrix (e.g. the corresponding coefficients of the inverse Jones matrix).

The Jones matrix may be generalized to a channel transfer matrix H(ω). The channel transfer matrix H(ω) of an optical (e.g. fiber) link may have the size m*p*i×n*p*i, where i ∈ {1, 2} (depending on whether the real and the imaginary part of the optical field are treated jointly or separately), p ∈ {1, 2} (depending on the number of orthogonal polarization states), and m ∈ M as well as n ∈ N depending on the number of linearly polarized (LP) modes propagating via the communication link (e.g. in the fiber). In this case, the communication link (channel) is considered as a m*p*i×n*p*i MIMO channel. Such a channel model is particularly useful for multi-core fiber (MCF) and multi-mode fiber (MMF) links, which may have a large number m and n of modes.

In a bi-directional coherent communication link, the optical signals may be generated by dual-polarization IQ transmitters and may be received by polarization and phase diversity digital coherent receivers as mentioned above. After transmitter-side digital signal processing, the four driving signals for the dual-polarization (DP) in-phase (I) and quadrature (Q) modulator (DP IQ modulator) are generated, the four driving signals being related to the in-phase component in the x-polarization (XI), the quadrature component in the x-polarization (XQ), the in-phase component in y-polarization (YI) and the quadrature component in y-polarization (YQ)) and being generated using digital-to-analog converters (DACs). The light of a laser source is modulated by the DP IQ modulator to produce the transmitted optical field E^{TX} (e.g. at the first party at point A). After transmission over the bi-directional communication link, the received optical field E^{RX} (e.g. at the second party at point B) is given by:

E^{RX}(ω)=H_{A→B}(ω)E^{TX}(ω)

After digitization by analog-to-digital converters (ADC), the frequency-dependent channel matrix H(ω) can be estimated by suitable channel estimation methods as set forth above. Due to the reciprocal nature of a bi-directional link, the estimated channel matrix H(ω) at both ends of the communication link (i.e. at both ends A, B of the link corresponding to the first and the second party) should be highly correlated for any given instant in time. The matrix H(ω) is also randomly time-varying, such that estimations at different time instants result in new correlated matrices (matrix coefficients).

For example, Alice (first party) and Bob (second party) want to communicate over the bi-directional communication link, wherein each of them uses a dual-polarization IQ transmitter and a coherent receiver. At the same (or approximately the same) time instant Alice and Bob perform a channel estimation (the first and the second channel estimation, e.g. based on training sequences as mentioned above). With respect to the 2×2 MIMO channel, the first and the second channel estimation each will yield the four channel impulse responses hₓₓ, h_{xy}, h_{yx} and h_{yy} corresponding to the coefficients of H(ω). A subsequent quantization of the estimated channel impulse responses hₓₓ, h_{xy}, h_{yx} and h_{yy} each yields a sequence of correlated bits. The correlated bit sequences produced by both Alice and Bob are finally used for producing at least one common secret key. Both Alice and Bob can use a suitable decoder on the correlated bit sequences for obtaining identical bit sequences with a very high probability as disclosed e.g. in the article J. E. Hershey, A. A. Hassan, R. Yarlagadda, “Unconventional cryptographic keying variable management,” IEEE Transactions on Communications, vol. 43, no. 1, p. 3, January 1995, which in that respect is also incorporated herewith.

The above consideration similarly applies to a 4×4 MIMO system. Denoting the transmitted optical field again as E^{TX} and the received field as E^{RX} and assuming dual-polarization and complex optical signals, the following relation can be derived:

$$[ \begin{matrix}{E}_{xr}^{RX} \\ {E}_{xi}^{RX} \\ {E}_{yr}^{RX} \\ {E}_{yi}^{RX}\end{matrix} ] = H ( ω ) [ \begin{matrix}{E}_{xr}^{TX} \\ {E}_{xi}^{TX} \\ {E}_{yr}^{TX} \\ {E}_{yi}^{TX}\end{matrix} ] = [ \begin{matrix}{H}_{11} & {H}_{12} & {H}_{13} & {H}_{14} \\ {H}_{21} & {H}_{22} & {H}_{23} & {H}_{24} \\ {H}_{31} & {H}_{32} & {H}_{33} & {H}_{34} \\ {H}_{41} & {H}_{42} & {H}_{43} & {H}_{44}\end{matrix} ] [ \begin{matrix}{E}_{xr}^{TX} \\ {E}_{xi}^{TX} \\ {E}_{yr}^{TX} \\ {E}_{yi}^{TX}\end{matrix} ] \qquad ( 2 )$$

wherein the indices x and y denote the polarization state and the indices r and i denote the real and imaginary part of the optical field, respectively. In this case, sixteen frequency-dependent coefficients of the transfer function (or equivalently time-dependent coefficients of the impulse response) are determined (e.g. estimated), wherein at least some of them might be used for generating the correlated bit sequences (and thus the at least one secret key).

The bi-directional optical communication link might be established using at least one optical fiber. For example, a single fiber is used for data transmission in both directions, i.e. from the first to the second party and from the second to the first party. However, it is also possible that at least a first and a second fiber (e.g. a fiber pair) is provided, wherein signals are transmitted from the first to the second party via the first fiber and signals are transmitted from the second to the first party via the second fiber. The fiber(s) used for establishing the optical communication link may be optical multi-core fibers and/or single-mode fibers and/or multi-mode fiber(s).

If a fiber pair is used, each party, for example, measures the concatenated bidirectional transfer function, i.e. H_{A→B→A}(ω)=H_{A→B}(ω)×H_{B→A}(ω)≈H_{B→A→B}(ω). The measurement of the concatenated bidirectional transfer function can be carried out as follows (described for H_{A→B→A}(ω)):

A transceiver at the first communication link end (fiber end A), i.e. at the side of the first party A, sends a signal to the second communication link end (fiber end), i.e. at the side of the second party B, a portion of the signal being intended for determining (e.g. estimating) H_{A→B}(ω). This portion of the signal is further redirected from the second fiber end B to the first fiber end A such that the transceiver at the first fiber end A is able to measure H_{A→B→A}(ω) and thus the concatenated bidirectional transfer function. Redirecting the signal portion from fiber end B to fiber end A might be carried out before coherent reception (e.g. by coupling the fiber end using appropriate means) or after coherent reception (e.g. by using digital redirection).

The invention is also related to a system for secure optical data transmission, in particular for carrying out the method as described above, the system comprising:
a bi-directional optical communication link between a first and a second party;
a first channel estimator device configured for carrying out a first channel estimation with respect to the communication link by the first party;
a second channel estimator device configured for carrying out a second channel estimation with respect to the communication link by the second party; and
a key generating device configured for generating a secret key or another token using the results of the first and the second channel estimation.

The system according to the invention may use at least some of the embodiments of the method according to the invention discussed above.

### BRIEF DESCRIPTION OF THE DRAWINGS

Embodiments of the invention are described hereinafter with reference to the drawings.

FIG. 1 a block diagram illustrating a principle design of a system for secure optical data transmission according an embodiment of the invention.

FIG. 2 a block diagram of an example of a transmitter of the system according to the invention.

FIG. 3 a block diagram related to a receiver which may be used in the system according to the invention.

FIG. 4 a block diagram related to another receiver which may be used in the system according to the invention.

FIG. 5 a block diagram of a fiber link which may be used in the system according to the invention.

FIG. 6 a block diagram of another fiber link which may be used in the system according to the invention.

FIG. 7 a block diagram illustrating an embodiment of the method for secure optical data transmission according the invention.

### DETAILED DESCRIPTION

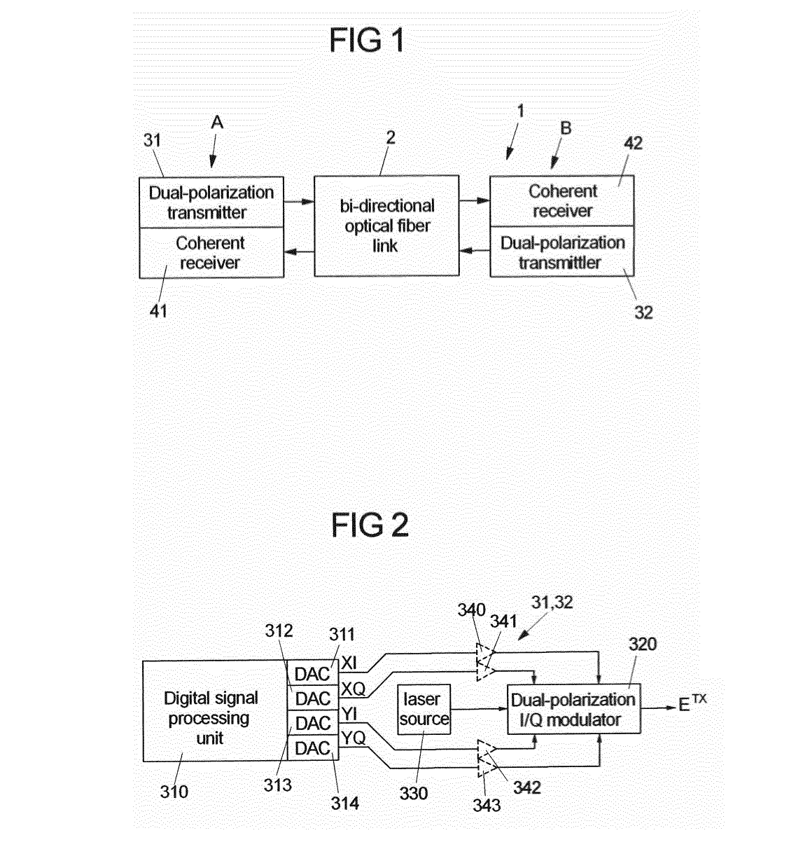

The system 1 for secure data transmission shown in FIG. 1 comprises a bi-directional optical communication link realized by a bi-directional optical fiber link 2 between a first party A and a second party B.

Data is transmitted and received from the first party A by means of a dual-polarization transmitter 31 and a coherent receiver 41, respectively. Similarly, the second party B transmits and receives data using a dual-polarization transmitter 32 and a coherent receiver 42.

Both the first and the second party A, B use a channel estimator (not shown) carrying out channel estimations with respect to the communication channel provided by the bi-directional optical fiber link 2. Further, the first and the second party A, B use a key generating device (not shown, either) configured for generating a secret key using the results of the channel estimations. The channel estimations carried out by the parties A, B in particular comprise the determination of coefficients of a transfer matrix H(ω) (see above) with respect to the bi-directional optical fiber link 2. Because dual-polarization transmitters are employed, the transfer function of the optical fiber link 2 can be described by the Jones matrix J(ω), the matrix coefficients being determined by the channel estimations as set forth in detail above (equation (1) above). If complex valued optical fields are considered, a 4×4 MIMO system might be considered as also discussed above (equation (2) above).

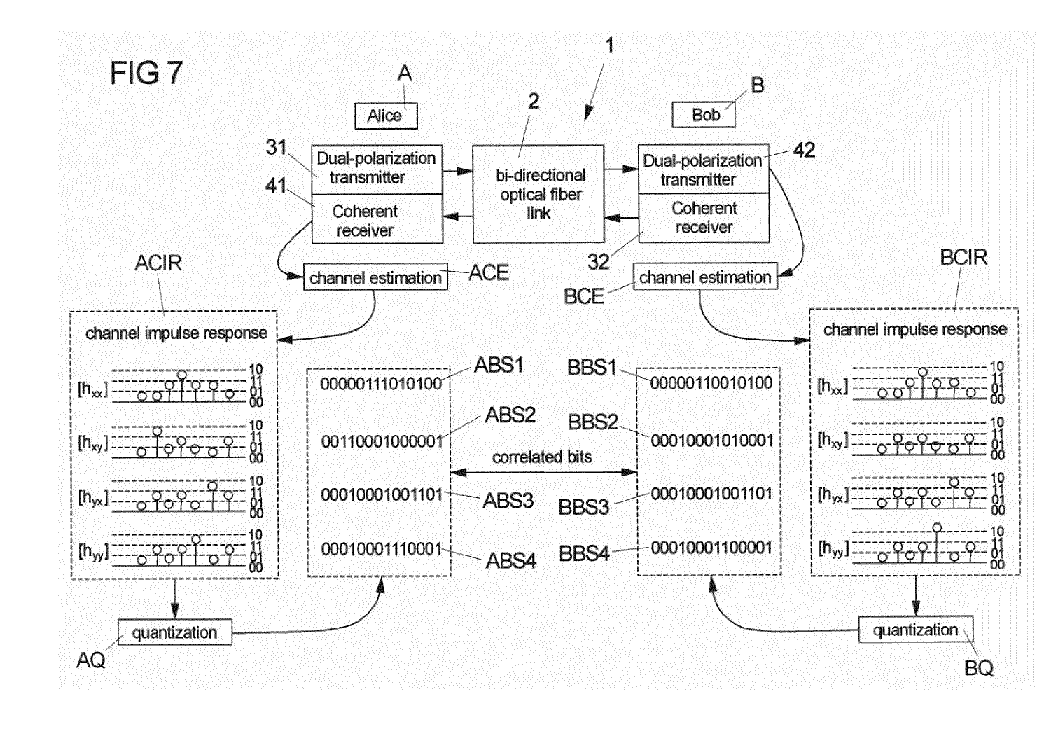

Using the results of the channel estimations, correlated bit sequences are determined (see also FIG. 7), the correlated bit sequences being a realization of a joint randomness not shared by others. Finally, secret keys or other tokens are created using the correlated bit sequences.

FIG. 2 depicts the layout of a dual-polarization transmitter (transmitter unit) 31, 32 that might be used in the system 1 shown in FIG. 1. The transmitter 31, 32 comprises a digital signal processing unit 310 whose output is supplied to four digital-to-analog converters (DACs 311-314). The DACs 311-314 generate four analog signals XI, XQ, YI and YQ, namely the in-phase component in the x-polarization (XI), the quadrature component in the x-polarization (XQ), the in-phase component in y-polarization (YI) and the quadrature component in y-polarization (YQ)).

The four driving signals XI, XQ, YI and YQ are supplied to a dual-polarization IQ modulator 320 used for modulating light of a laser source 330. The output of the IQ modulator 320 is the optical field E^{TX} to be transmitted via the optical communication link. The driving signals XI, XQ, YI and YQ optionally are amplified by means of driver amplifiers 340-343.

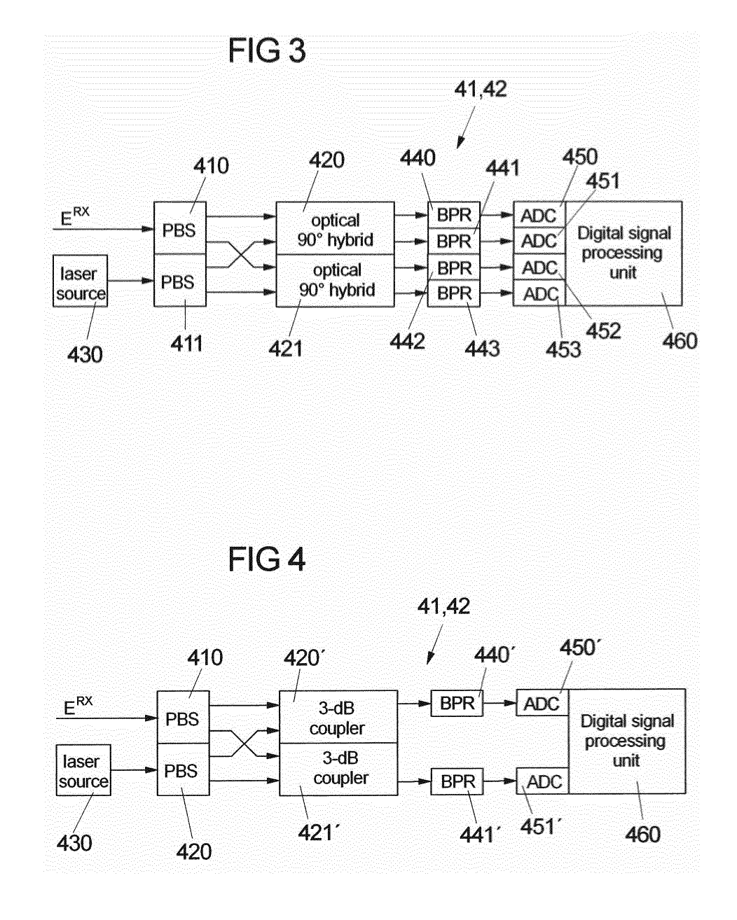

FIG. 3 shows an optical coherent receiver in the form of a homo-/intradyne receiver (receiver unit) 41, 42 that might be used as receiver at the side of the first and/or the second party A, B of the system 1 shown in FIG. 1.

The receiver 41, 42 is configured for receiving an optical field E^{RX} transmitted by a dual-polarization transmitter (such as the transmitter shown in FIG. 2) via the optical communication link. For this, the receiver 41, 42 comprises two polarization beam splitters 410, 411, wherein the received optical field E^{RX} is supplied to the first one (410) of the beam splitters. The beam splitter 410 generates two differently polarized output signals which are supplied to a first and a second mixer in the form of a 90° optical hybrid mixer 420, 421. Similarly, a signal of a laser source 430 is split into two signals by the other one (420) of the beam splitters, wherein the beam splitter output signals are transmitted to the mixers 420, 421.

The output signals generated by the mixers 420, 421 are received by four balanced photo receivers 440-443, wherein the output of the photoreceivers 440-443 (corresponding to the XI, XQ, YI and YQ components of the signal) is converted by four analog-to-digital converters (ADC 450-453) assigned to each one of the balanced photoreceivers 440-443. The converted signals may be processed by a digital signal processing unit 460. The digital signal processing unit 460 may realize the channel estimator and/or the secret key generator mentioned above.

The output of the ADC 450-453 in particular is used for generating the coefficients of the transfer matrix H(ω) according to equation (2).

FIG. 4 illustrates another embodiment of the receivers 41, 42, the receivers 41, 42 being heterodyne receivers. Different from FIG. 3, couplers (e.g. 3-dB couplers) 420′, 421′ are used as mixers. The output of each one of the couplers 420′, 421′ is received by a single balanced photoreceiver 440′, 441′. Accordingly, only two ADCs 450′, 451′ are used for converting the output of the receivers 440′, 441′.

FIG. 5 depicts a possibility of realizing a bi-directional optical communication link between the first and the second party, e.g. for realizing the optical fiber link 2 of FIG. 1. The fiber link 2 comprises a single optical fiber 21, wherein at the side of the first party A a first duplexer 22 is provided for coupling a signal into the optical fiber 21 and/or for receiving a signal from the optical fiber 21. Similarly, a second duplexer 23 is provided at the side of the second party B.

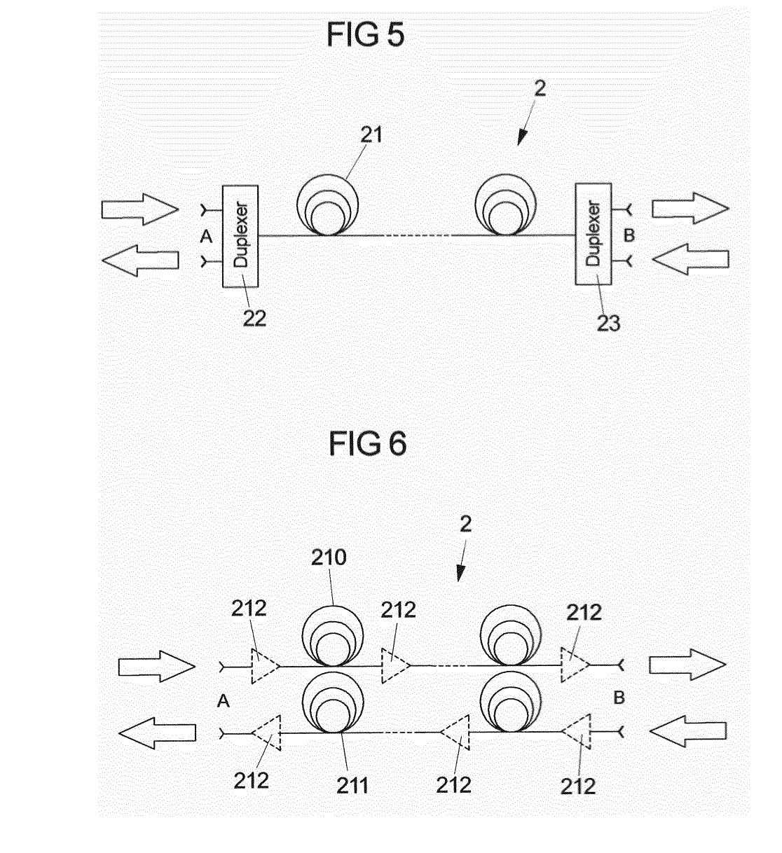

Another realization of the bi-directional optical communication link of the system according to the invention is illustrated in FIG. 6. Instead of a single fiber, a first and a second optical fiber 210, 211 is used, the fibers 210, 211 being used for transmitting a signal in one direction only, i.e. from the first party A to the second party B and from the second party B to the first party A, respectively. Optical amplifiers 212 might be provided for amplifying the signal transmitted via the first and/or the second optical fiber 210, 211. Such amplifiers might also be provided if a single optical fiber is used (FIG. 5). However, the amplifiers 212 are only optional.

FIG. 7 illustrates an embodiment of the method according to the invention, wherein the method is carried out using the system 1 shown in FIG. 1, i.e. using dual-polarization transmitters. It is noted, however, that the invention is not restricted to dual-polarization transmission. Rather, single polarization transmitters or, in general, transmitters for M×N MIMO systems might be used as well.

According to FIG. 7, Alice (first party A) and Bob (second party B) communicate over the bi-directional communication link 2, wherein each of them uses a dual-polarization transmitter 31, 32 and a coherent receiver 41, 42. At least approximately at the same point in time, both Alice and Bob carry out a channel estimation ACE, BCE (the first and the second channel estimation, e.g. based on transmitting training sequences over the communication link 2 as discussed above).

As already set forth above, the communication link 2 might be regarded as a 2×2 MIMO channel, wherein channel estimations carried out by Alice and Bob each will yield the four channel impulse responses hₓₓ, h_{xy}, h_{yx} and h_{yy}, as indicated by boxes ACIR and BCIR in FIG. 7.

A subsequent quantization AQ, BQ of both the channel impulse responses hₓₓ, h_{xy}, h_{yx} and h_{yy} determined by Alice and Bob results in a plurality of bit sequences ABS 1-ABS 4 and BBS 1-BBS 4 assigned to Alice and Bob, respectively. Each one of the bit sequences ABS 1-ABS 4 and BBS 1-BBS 4 is associated with one of the channel impulse responses hₓₓ, h_{xy}, h_{yx} and h_{yy}.

As the channel estimations carried out by Alice and Bob will lead to very similar or even identical results for the channel impulse responses hₓₓ, h_{xy}, h_{yx} and h_{yy}, the bit sequences ABS 1-ABS 4 determined by Alice are correlated (e.g. very similar or even identical) to the bit sequences BBS 1-BBS 4 determined by Bob. Thus, the bit sequences ABS 1-ABS 4 and BBS 1-BBS 4 generate joint randomness not shared by others. It is noted that the bit sequences ABS 1-ABS 4 and BBS 1-BBS 4 might differ slightly, e.g. because of non-perfect channel estimations (e.g. caused by signal noise). Using their bit sequences ABS 1-ABS 4 and BBS 1-BBS 4, respectively, both Alice and Bob may create a secret key and use the secret key for data transmission via the bi-directional communication link.

Of course, other transmission schemes may be used or other transmission models (such as the 4×4 MIMO scheme mentioned above) may be considered for determining the correlated bit sequences.

1. A method for secure optical data transmission, comprising the steps of:
providing a bi-directional optical communication link between a first and a second party;
carrying out a first channel estimation with respect to the communication link by the first party;
carrying out a second channel estimation with respect to the communication link by the second party; and
generating a secret key or another token using the results of the first and the second channel estimation.

2. The method as claimed in claim 1, wherein carrying out the first channel estimation comprises transmitting a pilot sequence from the first to the second party and/or carrying out the second channel estimation comprises transmitting a pilot sequence from the second to the first party.

3. The method as claimed in claim 1, wherein the first and/or the second channel estimation is carried out by using payload data.

4. The method as claimed in claim 1, wherein the first and the second channel estimation are carried out at least approximately at the same point in time.

5. The method as claimed in claim 2, and wherein the first and the second channel estimation are carried out at least approximately at the same point in time, wherein transmitting the pilot sequence from the first to the second party and transmitting the pilot sequence from the second to the first party is carried out at least approximately at the same point in time.

6. The method as claimed in claim 1, wherein the bi-directional optical communication link is an M×N multiple input multiple output communication link.

7. The method as claimed in claim 6, wherein the bi-directional optical communication link is a 2×2 MIMO or a 4×4 MIMO link.

8. The method as claimed in claim 1, wherein using the results of the first and the second channel estimation correlated bit sequences are generated, the secret key being generated by means of the correlated bit sequences.

9. The method as claimed in claim 1, wherein first and/or the second channel estimation comprises determining coefficients with respect to impulse responses in the time domain and/or transfer functions in the frequency domain with respect to the communication link.

10. The method as claimed in claim 9, wherein the coefficients related to the impulse responses and/or transfer functions are quantized.

11. The method as claimed in claim 8, wherein the coefficients related to the impulse responses and/or transfer functions are quantized and wherein the correlated bit sequences are generated using the determined coefficients of the impulse responses and/or transfer functions.

12. The method as claimed in claim 1, wherein a bi-directional optical communication link is established using a first transmitter unit and a first receiver unit on the side of the first party and using a second transmitter unit and a second receiver unit on the side of the second party.

13. The method as claimed in claim 12, wherein the first and/or the second transmitter unit is configured for transmitting signals via at least a first and a second optical transmission variant.

14. The method as claimed in claim 13, wherein the first optical transmission variant is a first carrier polarization and the second optical transmission variant is a second carrier polarization.

15. The method as claimed in claim 14, wherein the first and/or the second transmitter unit comprises a dual polarization modulator.

16. The method as claimed in claim 12, wherein the first and/or the second receiver unit is configured for receiving signals transmitted via a first and a second carrier polarization.

17. The method as claimed in claim 16, wherein the first and/or the second receiver unit is configured for coherent detection.

18. The method as claimed in claim 1, wherein the bi-directional optical communication link is established using at least one optical fiber.

19. The method as claimed in claim 18, wherein the fiber optical communication link comprises at least one optical multi-core fiber, single-mode fiber and/or multi-mode fiber.

20. A system for secure optical data transmission comprising:
a bi-directional optical communication link between a first and a second party;
a first channel estimator device configured for carrying out a first channel estimation with respect to the communication link by the first party;
a second channel estimator device configured for carrying out a second channel estimation with respect to the communication link by the second party; and
a key generating device configured for generating a secret key or another token using the results of the first and the second channel estimation.
